(19) United States
(12) Patent Application Publication
(10) Pub. No.: US 2009/0252989 A1
(43) Pub. Date: Oct. 8, 2009

(54) Laminated Viscoelastic Damping Structure And Method Of Making The Same

(75) Inventors: Rick Swanson, Frankfort, IL (US); Alan Hufnagel, Ann Arbor, MI (US)

Correspondence Address: QUINN LAW GROUP, PLLC, 39555 ORCHARD HILL PLACE, SUITE # 520, NOVI, MI, 48375, US

(73) Assignee: MATERIAL SCIENCES CORPORATION, Elk Grove Village, IL (US)

(21) Appl. No.: 12/099,528

(22) Filed: Apr. 8, 2008

(51) Int. Cl. B32B 9/00; B29C 65/00

(52) U.S. Cl. 428/699; 156/60

(57) ABSTRACT

The present invention provides a laminate structure for attenuating vibration and damping noise, and a method for manufacturing the same. The laminate structure includes first and second metallic constraining layers, and a viscoelastic layer disposed between and bonded to both constraining layers. The viscoelastic layer includes an amount of an external cross-linking agent, such as metal acetylacetonate, in excess of a stoichiometric quantity thereof. The laminate structure also includes a layer of 100% inorganic, hexavalent chrome free pretreatment, such as aqueous chromium (III) phosphate-silicate, disposed between and bonded to the viscoelastic layer and each constraining layer. The method includes: applying a layer of pretreatment to the first and second constraining layers; applying the viscoelastic layer to one or both constraining layers; and laminating the constraining layers, wherein each of the constraining layers has a concave up coil orientation disposed in opposing relation to one another prior to laminating.

### TECHNICAL FIELD

The present invention relates generally to damping structures, and more particularly to laminated damping structures having a viscoelastic core for attenuating vibration and damping resultant noise, and methods of making the same.

### BACKGROUND OF THE INVENTION

Electrical fans consist generally of two primary components: a prime mover in driving communication with one or more movable vanes or fan blades. An axial-flow fan has blades that force air to move parallel to the shaft about which the blades rotate. An axial-flow fan blade with a structural resonance close in frequency to an excitation frequency of the motor driving the fan may vibrate, increasing the overall noise level of the fan. The increased noise is due, in part, to the structural resonance mode shape of the fan blade being excited by the motor. Such excitation may cause vibration of the fan blades, resulting in a tonal noise being audible. Increased noise levels and the tonality of the resonance will degrade the sound quality of the fan.

Engineers of single-speed fans (e.g., fan blades driven by a single-speed motor) have been able to design around this problem by intentionally tuning the resonant frequencies of the fan blades away from the motor excitation frequencies. However, in recent years, variable speed fans have been introduced to improve the efficiency of air conditioners, as rated by the Seasonal Energy Efficiency Ratio (SEER), which is defined by the Air Conditioning and Refrigeration Institute. In this instance, tuning the resonant frequency of the fan blades away from the motor may be ineffective because the excitation frequency is no longer a constant value.

One prior art approach to damping noise generated by variable speed fans is to make the fan blade stiffer and, thus, increase the fan blade resonant frequency beyond the motor excitation frequency range. Increasing the stiffness of the fan blade will normally require that the gauge of the fan blade be significantly increased. Any such increase, however, raises material costs and the cost of manufacture, and requires a larger and, thus, more expensive motor to spin the blade assembly.

Another proposed means for ameliorating undesirable noise generated by variable speed fans is to use “add-on” damping treatments. Attaching a layer of viscoelastic material to component parts of a mechanical or electromechanical system is known to reduce vibration, helping to diminish the unwanted propagation of structure-borne noise and the transmission of airborne noise. Traditionally, the “add-on” damping structure comprises a viscoelastic layer laminated between an adhesive layer and a metallic constraining layer. The adhesive layer is used to attach the “add-on” treatment to a constituent part of the fan assembly.

A force applied to the constraining layers, such as a force from vibrations generated by a motor assembly, drives the viscoelastic material into shear along the constraining layers, thereby converting a substantial amount of mechanical energy into heat. The damping reduces the amplitude of any vibrations, decreasing the noise level of the fan. Increasing the shear within the damping structure, therefore, also increases the energy dissipating characteristics therein. The ability of the damping structure to damp vibrations is known as its “loss factor”, with a higher loss factor indicating greater damping capability. The loss factor for a given damping structure is a function of both temperature and vibrational frequency within the damping structure.

Typical viscoelastic materials, for example, acrylics, silicones, rubbers and other plastics, have a relatively low stiffness, which can cause undesirable compression within the damping structure. While reducing the thickness of the viscoelastic layer creates a stiffer assembly, a reduction in loss factor also results. Therefore, it is desirable to provide a damping structure with an increased overall stiffness without sacrificing damping efficiency.

While “add-on” treatments do provide some vibrational damping, it limits or complicates certain post-processing and fabrication operations, such as finishing and balancing the fan blades. In addition, “add-on” damping treatments disrupt the flow of air over the fan blades, potentially denigrating the aerodynamic qualities and general functionality of the fan. Finally, “add-on” treatments have limited damping characteristics, and are more expensive to manufacture due to the additional steps required to apply the “add-on” to the fan blades after stamping.

### SUMMARY OF THE INVENTION

The present invention provides a laminate structure utilizing a viscoelastic core for attenuating vibration and damping resultant noise, as well as an improved method of manufacturing the same. The laminates of the present invention are tunable to provide maximum damping performance under a diverse range of operating temperatures and frequencies. In addition, a laminate damping structure fabricated in accordance with the methods of the present invention will not delaminate during assembly or throughout its operational life. Finally, the laminated damping structures offer sufficient stiffness so that the static and dynamic stiffness of a product formed therefrom, such as a fan blade, can be adjusted to meet individual engineering design requirements.

According to one embodiment of the present invention, a laminate structure for attenuating vibration and damping noise is provided. The laminate structure includes a first metallic constraining layer, a second metallic constraining layer, and a viscoelastic layer disposed between and bonded to both constraining layers. The viscoelastic layer includes an amount of an external cross-linking agent, such as metal acetylacetonate, in excess of a stoichiometric quantity of the cross-linking agent.

According to one aspect of this embodiment, the laminate structure also includes one or more layers of hexavalent chrome free pretreatment, each disposed between and bonded to the viscoelastic layer and one of the constraining layers. Ideally, the hexavalent chrome free pretreatment is an aqueous chromium (III) phosphate-silicate, and is preferably 100% inorganic. Each layer of hexavalent chrome free pretreatment preferably has a total coating weight of approximately 161 to 269 milligrams per square meter (mg/m²) (15-25 milligrams/square foot).

According to another aspect of this embodiment, the laminate structure also includes one or more layers of RoHS (Restriction of Hazardous Substances Directive) compliant fluorotitanate-fluorozirconate pretreatment, each disposed between one of the layers of hexavalent chrome free pretreatment and a respective constraining layer.

In accordance with another aspect, the first and second constraining layers are aluminum. Moreover, the viscoelastic layer preferably consists essentially of a polymeric acrylic. To this regard, the viscoelastic layer has a minimum shear strength of 3 megapascals (MPa), and a moderate room temperature peel resistance of approximately 90-143 kilograms per meter width (piw) (5-8 pounds per inch width).

In accordance with another embodiment of the present invention, a laminate structure for attenuating vibration and damping noise is provided, including first and second metallic constraining layers, and a viscoelastic layer disposed between, and extending substantially the entirety of the first and second metallic constraining layers. In addition, a first layer of hexavalent chrome free pretreatment is disposed between and bonded to the first constraining layer and the viscoelastic layer, whereas a second layer of hexavalent chrome free pretreatment is disposed between and bonded to the second constraining layer and the viscoelastic layer. Each layer of hexavalent chrome free pretreatment comprises of an aqueous chromium (III) phosphate-silicate, and is preferably 100% inorganic.

According to one aspect of this embodiment, the viscoelastic layer includes an amount of an external cross-linking agent in excess of a stoichiometric quantity thereof. The external cross-linking agent preferably consists essentially of a metal acetylacetonate.

In accordance with another aspect, the laminate structure also includes a first layer of fluorotitanate-fluorozirconate pretreatment disposed between and bonded to the first constraining layer and the first layer of hexavalent chrome free pretreatment. Additionally, a second layer of fluorotitanate-fluorozirconate pretreatment is disposed between and bonded to the second constraining layer and the second layer of hexavalent chrome free pretreatment.

The laminated damping structures of the present invention offer a number of key advantages over prior art approaches to attenuating undesirable noise generated by variable speed fan assemblies. First, the laminated structure is completely compatible with current post-processing and fabrication operations—e.g., stamping, forming, painting, assembly, balancing, etc. Secondly, unlike fan assemblies utilizing “add-on” damping treatments, the aerodynamic characteristics of a fan blade formed from a laminate damping structure of the present invention are not affected, as there are no additional parts added to the blade. Thirdly, the laminated damping structure is completely RoHS (Restriction of Hazardous Substances Directive) compliant. Finally, a fan blade fabricated from a laminated damping structure of the present invention can be integrated with little or no modification to the current fan assembly.

According to another embodiment of the present invention, a method of manufacturing a laminate damping structure with at least one viscoelastic core disposed between and bonded to first and second metallic constraining layers is provided. The method includes the steps of: applying the viscoelastic layer to one or both constraining layers; and laminating the first constraining layer to the second constraining layer, wherein the first constraining layer has a concave down coil orientation that is disposed in opposing relation to the second constraining layer which has a concave up coil orientation prior to laminating the two members together.

The method preferably also includes: uncoiling the first constraining layer from a first coil of sheet metal in an underhand manner prior to applying the first layer of pretreatment; rewinding the first constraining layer into a second coil of sheet metal in an overhand manner after applying the first layer of pretreatment; uncoiling the second constraining layer from a third coil of sheet metal in an underhand manner prior to applying the second layer of pretreatment; and uncoiling the third coil of sheet metal in an underhand manner prior to laminating the first and constraining layers together.

It is further preferred that the method include: adding an amount of an external cross-linking agent to the viscoelastic layer prior to applying the viscoelastic layer. The amount of external cross-linking agent added is significantly greater than the stoichiometric quantity of the cross-linking agent.

Prior to laminating the two constraining layers together, the method preferably includes: applying a first layer of aqueous chromium (III) phosphate-silicate to the first constraining layer over the first layer of pretreatment, and applying a second layer of aqueous chromium (III) phosphate-silicate to the second constraining layer over the second layer of pretreatment.

It is also preferred that method include: applying a first layer of pretreatment to the first constraining layer, and applying a second layer of pretreatment to the second constraining layer, both prior to laminating the first constraining layer to the second constraining layer. The first and second layers of pretreatment consist essentially of fluorotitanate-fluorozirconate immersion pretreatment.

The above features and advantages, and other features and advantages of the present invention will be readily apparent from the following detailed description of the preferred embodiments and best modes for carrying out the present invention when taken in connection with the accompanying drawings and appended claims.

### BRIEF DESCRIPTION OF THE DRAWINGS

FIG. 1 is a schematic side-view illustration of a laminate damping structure in accordance with a preferred embodiment of the present invention;

FIG. 2 is a schematic illustration of one portion of an exemplary coil coating and lamination assembly for practicing the methods of the present invention;

FIG. 3 is a schematic illustration of another portion of the exemplary coil coating and lamination assembly for practicing the methods of the present invention; and

FIG. 3A is an elevated schematic illustration of a portion of the coil coating and lamination assembly of FIG. 3 depicting the coil set orientations of the first and second constraining layers just prior to marrying the two members together.

### DESCRIPTION OF THE PREFERRED EMBODIMENTS

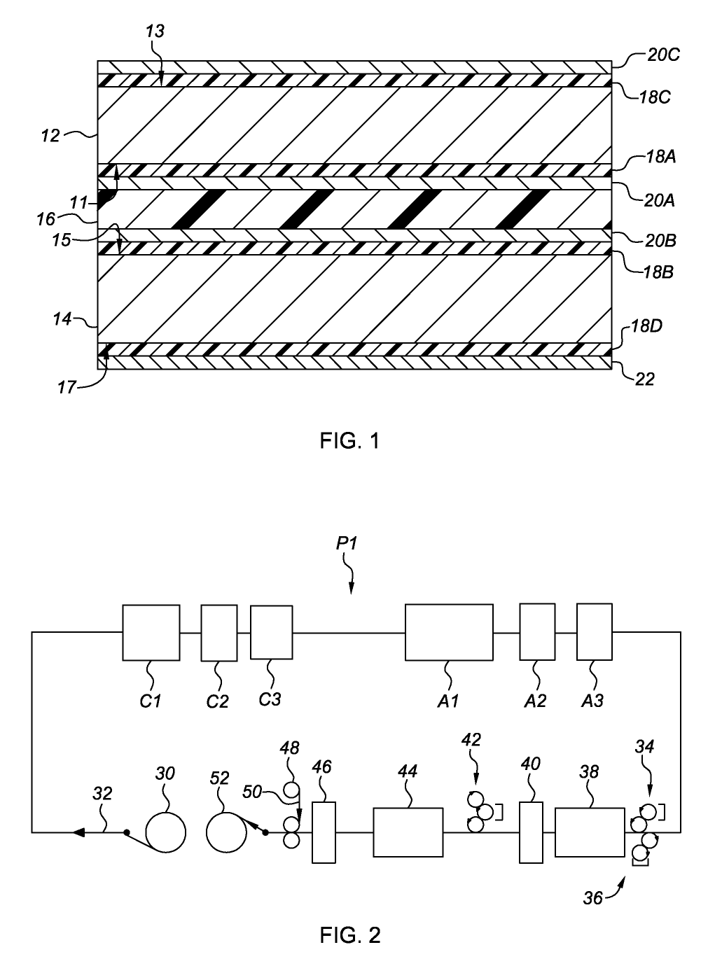

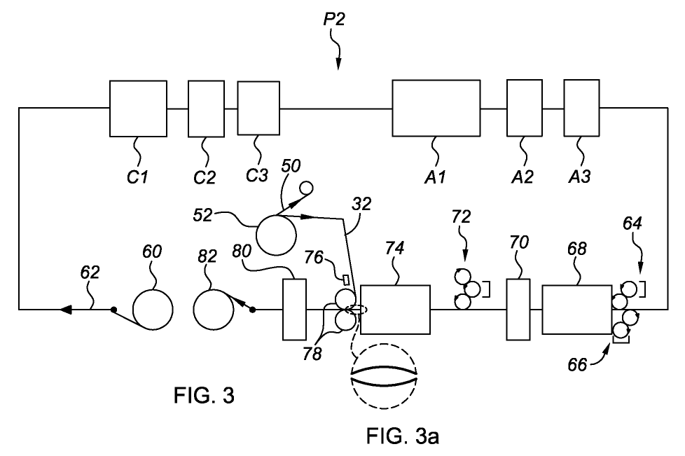

Referring to the drawings, wherein like reference numbers refer to like components throughout the several views, FIG. 1 schematically depicts a constrained layer laminate damping structure, identified generally at 10 and referred to hereinafter as “laminate structure” or “CLD”, in accordance with the present invention. The embodiments of the present invention will be described herein with respect to the structure illustrated in FIG. 1 and the arrangement presented in FIGS. 2-3. It should be readily understood that the present invention is by no means limited to the exemplary illustrations presented in FIGS. 1-3. In addition, the drawings presented herein are not to scale and are provided purely for explanatory purposes. Thus, the specific and relative dimensions shown in the drawings are not to be considered limiting.

The laminate structure 10 of FIG. 1 includes a first metallic constraining layer (or skin) 12 and a second metallic constraining layer (or skin) 14 in opposing relation thereto. A layer of viscoelastic material (referred to hereinafter as “viscoelastic layer”) 16 is disposed between, and spans substantially the entirety of (i.e., is coextensive with) the first and second constraining layers 12 and 14. The first and second constraining layers 12, 14 may be formed from any material with the necessary stiffness and structural durability for the intended application of the laminated damping structure 10. By way of example, the first and second constraining layers 12, 14 are preferably fabricated from aluminum. Moreover, the viscoelastic layer 16 preferably consists of a solution polymeric acrylic with a target viscosity of 950-1050 Centipoise (cps). To this regard, the viscoelastic layer 16 will ideally offer a minimum shear strength of 3 megapascals (MPa), a moderate room temperature peel resistance of approximately 90-143 kilograms per meter width (piw) (5-8 pounds per inch width), a peak temperature of 630 degrees Celsius (° C.) or 1166 degrees Fahrenheit (° F.), and 100° C. continuous maximum durability (212° F.).

The viscoelastic core 16 in laminate structure 10 is engineered to retain a predetermined percentage of fastener torque in compression through cross-linking and thereby improve stress relaxation by utilizing a minimal dry film thickness and/or containing inorganic particles for reinforcement. By way of example, the viscoelastic layer 16 is formulated with an excess of external cross-linking agent—i.e., an amount in excess of a stoichiometric quantity thereof, in order to counteract a reduction in shear adhesion properties upon accelerated aging. The external cross-linking agent is preferably chosen from the family of metal acetylacetonates. By adding a very high excess of external cross-linking agent (preferably on the order of 105.9% stoichiometric weight ratio) to the left side of the equilibrium reaction for forming the viscoelastic core 16, the production of products on the right side is drastically increased. That is, depolymerization of the viscoelastic core is not thermodynamically favored.

As will be explained in extensive detail hereinbelow, the viscoelastic layer 16 is bonded or adhered to the two constraining layers 12, 14. Sandwiching the viscoelastic layer 16 between the first and second constraining layers 12 and 14 provides noise and vibration reduction for an assembly or device fabricated from or employing the same, thereby eliminating the need for additional parts or materials to provide damping. Specifically, the first and second constraining layers 12, 14 will tend to undergo deformation due to vibrational forces generated, for example, by motor excitation. Since the viscoelastic layer 16 is bonded to both constraining layers 12, 14, deformation forces exacted along the outer surfaces 13, 17 of the first and second constraining layers 12, 14 are transferred to the viscoelastic layer 16. These forces shear across the viscoelastic layer 16, since the viscoelastic layer 16 is constrained by the outer and inner layers 12, 14, which attenuates and absorbs the deformation energy and dissipates it into heat, thereby damping noise and vibrations.

The laminate structure 10 also includes various layers of RoHS (Restriction of Hazardous Substances Directive) compliant immersion-type pretreatments that coat the inner and outer surfaces of the first and second constraining layers 12, 14. Specifically, first and second layers of fluorotitanate-fluorozirconate pretreatment, indicated respectively as 18A and 18B in FIG. 1, span substantially the entirety of respective inner surfaces 11 and 15 of the first and second constraining layers 12, 14. In a similar regard, third and fourth layers of fluorotitanate-fluorozirconate pretreatment, indicated respectively as 18C and 18D, span substantially the entirety of respective outer surfaces 13 and 17 of the first and second constraining layers 12, 14. The various layers of RoHS (Restriction of Hazardous Substances Directive) compliant immersion-type pretreatments 18A-18D are intended to provide improved adhesion and increased corrosion resistance. Each layer of fluorotitanate-fluorozirconate pretreatment 18A-18D preferably has a total coating weight of approximately 3.23 to 10.76 milligrams per square meter (mg/m²) (0.3-1.0 milligrams/square foot).

The laminate structure 10 also features one or more layers of RoHS compliant dried-in-place hexavalent chrome free pretreatment, each disposed between the viscoelastic layer 16 and one of the constraining layers 12, 14. More particularly, a first layer of hexavalent chrome free pretreatment 20A is disposed between and bonded to the viscoelastic layer 16 and first constraining layer 12 (i.e., the first layer of fluorotitanate-fluorozirconate pretreatment 18A). A second layer of hexavalent chrome free pretreatment 20B is disposed between and bonded to the viscoelastic layer 16 and second constraining layer 14 (i.e., the second layer of fluorotitanate-fluorozirconate pretreatment 18B). Employing combination pretreatment layers—that is, the collaborative layering of first layer of hexavalent chrome free pretreatment 20A over first layer of fluorotitanate-fluorozirconate pretreatment 18A, and second layer of hexavalent chrome free pretreatment 20B over second layer of fluorotitanate-fluorozirconate pretreatment 18B, improves adhesion of the viscoelastic core 16 with the first and second constraining layers 12, 14. In an instance where aluminum constraining layers are used, the combination pretreatment layers will also enhance robustness of the adhesive bond between the polymeric core 16 with constraining layers 12, 14 by diluting the catalytic effect of bare aluminum/aluminum oxide surfaces.

Notably, the laminate structure 10 may include additional constraining layers, additional viscoelastic layers, additional pretreatment layers, and various other additional layers (e.g., an electro-galvanized coating, dichromate paint, zinc plating, etc.) without departing from the intended scope of the present invention. By way of example, the outer surface 13 of the first metallic constraining layer 12 incorporates a third layer of hexavalent chrome free pretreatment 20C, which spans over or covers the third layer of fluorotitanate-fluorozirconate pretreatment 18C. The third layer of hexavalent chrome free pretreatment 20C helps to improve corrosion resistance of the outer surface 13 of the first metallic constraining layer 12. In a similar respect, the laminate structure 10 features a layer of paint 22, which spans over or covers the fourth layer of fluorotitanate-fluorozirconate pretreatment 18D. Ideally, each layer of hexavalent chrome free pretreatment 20A-20C is an aqueous chromium (III) phosphate-silicate, and is preferably 100% inorganic. Each layer of hexavalent chrome free pretreatment preferably has a total coating weight of approximately 161 to 269 milligrams per square meter (mg/m²) (15-25 milligrams/square foot). Notably, the third layer of chromium (III) phosphate-silicate 20C can be disregarded if a paint coating is required for both sides of the laminate structure 10, or if deemed not necessary by the application's specific requirements for product life

An exemplary coil coating and lamination assembly for practicing the methods of the present invention is schematically shown in FIGS. 2 and 3 of the drawings, divided into two primary segments—pass one P1 in FIG. 2 and pass two P2 in FIG. 3. The present invention is described herein with respect to the arrangement illustrated in FIGS. 2 and 3 as an exemplary application by which the methods of the present invention may be practiced. The present invention, however, may also be employed in other coating and lamination assemblies. Furthermore, the methods of the present invention preferably include at least those steps identified below. Nevertheless, it is within the scope and spirit of the claimed invention to omit steps, include additional steps, and/or modify the order presented herein.

Referring first to FIG. 2, a first strip of sheet metal 32, which may be considered the first metallic constraining layer 12 prior to processing and lamination, is pulled or uncoiled from a first coil of metal sheet stock 30 in an underhand manner (most commonly referred to as an underhanding payoff). The first strip of sheet metal 32 is fed or passed through a series of cleaners C1 through C3, each operable to wash and cleanse the sheet metal 32. In the exemplary embodiment of FIG. 2, the first cleaner C1 is a high temperature cleansing device which dispenses, for example, various alkaline treatments that remove grease, oil, finger prints, and organic debris from the strip of sheet metal 32. The second and third cleaners C2, C3 constitute a series of hot water rinses which remove the alkaline treatment from C1 and eliminate any remaining debris or particulate buildup.

After the first strip of sheet metal 32 is properly cleaned, it is fed or passed through an immersion-type pretreatment apparatus A1. Specifically, the pretreatment apparatus A1 coats both sides of the first strip of sheet metal 32 with a RoHS compliant fluorotitanate-fluorozirconate immersion pretreatment (i.e., applying the first and third layers of fluorotitanate-fluorozirconate pretreatment 18A and 18C of FIG. 1). The immersion pretreatment is followed by a gentle washing in first and second ambient water rinses A2 and A3, respectively, with a subsequent squeegee, rinse, and air knife.

With continuing reference to FIG. 2, the first strip of sheet metal 32 is transferred from the wet section of the coil coating and lamination assembly (i.e., cleaners C1-C3 and immersion pretreatment A1-A3), and fed or passed through a first coating device, such as top and bottom prime coaters, indicated generally as 34 and 36, respectively. The top and bottom prime coaters 34, 36 operate to apply a layer or coating of RoHS compliant dried-in-place hexavalent chrome free pretreatment (i.e., first and third layers of hexavalent chrome free pretreatment 20A and 20C of FIG. 1) to respective top and bottom sides of the first strip of sheet metal 32, in a substantially continuous and uniform manner. In other words, the top coater 34 coats the inner surface 11 of the first constraining layer 12, applying the first layer of hexavalent chrome free pretreatment 20A over the first layer of fluorotitanate-fluorozirconate pretreatment 18A. Synonymously, the bottom coater 36 coats the outer surface 13 of the first constraining layer 12, applying the third layer of hexavalent chrome free pretreatment 20C over the third layer of fluorotitanate-fluorozirconate pretreatment 18C. As noted above, the hexavalent chrome free pretreatment is preferably characterized as an aqueous chromium (III) phosphate-silicate, which is preferably 100% inorganic, and has a total coating weight of approximately 15-25 mg/ft².

The various layers of hexavalent chrome free pretreatment are thereafter dried in-place and cured by passing the pretreated strip of sheet metal 32 through a heating device, such as first prime oven 38. The temperature of the pretreated strip of sheet metal 32 is then rapidly cooled by a first quenching device 40. According to preferred practice, the first quenching device 40 is configured to quench only the bottom surface of the first strip of sheet metal 32.

The viscoelastic core (i.e., viscoelastic layer 16 of FIG. 1) may be applied in a single coat, or as part of a split-coat lamination process. In regard to the latter option, a portion of the viscoelastic core is applied to the inner surface 11 of the first constraining layer 12, and a portion is also applied to the inner surface 15 of the second constraining layer 14. In so doing, the split coat lamination process improves the “quality of adhesion”—i.e., intensity of the molecular bond, between the constraining layers 12, 14 and the viscoelastic layer 16. If a split-coat operation is used to apply the viscoelastic core, the now twice-pretreated strip of sheet metal 32 is passed or fed through a second coating device, represented herein by a 3-roll reverse finish coater, which is identified generally by reference numeral 42 in FIG. 2. The finish coater 42 is operable to apply a portion of the viscoelastic core to the first strip of sheet metal 32 in a substantially continuous and uniform manner, for a target total coating weight of 50-60 mg/ft².

The coated and pretreated strip of sheet metal 32 is then passed through another heating device, such as a first finish oven 44, drying, for example, to a peak metal temperature of about 171-193° C. (340-380° F.). In this instance, the temperature of the adhesive-coated sheet metal is thereafter rapidly cooled, which is accomplished in the arrangement of FIG. 2 with a second water quenching device 46 (which is configured to quench both sides of the sheet metal 32), followed by an air knife. An interleaf layer 50 is then pulled from film payoff 48, and applied over the upper surface of the sheet metal 32 (i.e., inner surface 11 of FIG. 1) to protect the viscoelastic material applied thereto. The first strip of sheet metal 32 is subsequently rewound into first rewind coil 52 in an overhand manner (most commonly referred to as an overhanding rewind).

In pass two P2 of the coil coating and lamination process, which is schematically illustrated in FIG. 3 of the drawings, a second strip of sheet metal 62, which may be considered the second metallic constraining layer 14 prior to processing and lamination, is pulled or uncoiled from a second coil of metal sheet stock 60 in an underhand manner. Similar to the first strip of sheet metal 32 of FIG. 2, the second strip of sheet metal 62 of FIG. 3 is passed through a wet section, characterized at least in part by cleaners C1-C3 and immersion pretreatment A1-A3 (which may be the same wet section in FIG. 2 in an instance where the same assembly line is being used to pretreat both strips of sheet metal 32, 62).

The second strip of sheet metal 62 is thereafter transferred from the wet section of the coil coating and lamination assembly, and passed through a third coating device, such as top and bottom prime coaters that are respectively identified in FIG. 3 at 64 and 66. The top coater 64 operates to apply a coating of RoHS compliant dried-in-place hexavalent chrome free pretreatment to the top side of the second strip of sheet metal 62, in a substantially continuous and uniform manner. In other words, the top coater 64 coats the inner surface 15 of the second constraining layer 14, applying the second layer of hexavalent chrome free pretreatment 20B over the second layer of fluorotitanate-fluorozirconate pretreatment 18B. In contrast to the arrangement of FIG. 2, the bottom coater 66 of FIG. 3 coats the bottom side of the second strip of sheet metal 62 (i.e., outer surface 17 of the second constraining layer 14) with a layer of finishing paint 22, which is applied over the fourth layer of fluorotitanate-fluorozirconate pretreatment 18D.

The layer of paint coating and the layer of dried-in-place hexavalent chrome free pretreatment are thereafter cured by passing the coated strip of sheet metal 62 through a heating device, such as second prime oven 68, to a peak metal temperature of approximately 199-216° C. (390-420° F.). One advantage to utilizing the chromium III phosphate-silicate pretreatment over its partially organic counterparts is that the 100% inorganic pretreatment will not begin to decompose at very high temperatures (e.g., those required for paint curing). The temperature of the pretreated strip of sheet metal 62 is then rapidly cooled by a third quenching device 70, followed by an air knife. Similar to the first quenching device 40 of FIG. 2, the third quenching device 70 of FIG. 3 is configured to quench only the bottom side of the second strip of sheet metal 62.

The now twice-pretreated strip of sheet metal 62 is passed or fed through a fourth coating device, represented herein by a 3-roll reverse finish coater, which is identified generally in FIG. 2 at 72. The finish coater 72 is operable to apply a portion of the viscoelastic core to the sheet metal 62 in a substantially continuous and uniform manner, for a target total coating weight of 50-60 mg/6 in² and, thus, a total core weight of 101-121 mg/6 in². As explained above, the finish coater 72 may be configured to apply either a predetermined portion of the layer of adhesive 16 of FIG. 1 if a split coat operation is being employed, or the entire layer of adhesive 16 of FIG. 1 if a single coat operation is utilized. The same applies to pass one P1 (i.e., the A-pass) in which the entire layer 16 is applied to the first strip of sheet metal 32 by the second coating device 42. The coated and pretreated strip of sheet metal 62 is then passed through another heating device, such as a second finish oven 74, drying and curing, for example, to a peak metal temperature of about 171-216° F. (340-380° C.).

Once the first and second strips of sheet metal 32, 62 are thoroughly cleaned, properly pretreated, and coated with the viscoelastic core, the two are thereafter laminated or married together. According to the arrangement of FIG. 3, the first rewind coil 52 of the pretreated and coated sheet metal 32 from pass one P1 is unwound in an overhand manner, the interleaf layer 50 removed from the upper surface thereof, and then heated—e.g., via a set of flame bars 76, to activate the portion of the viscoelastic core applied thereto. Heating the first strip of sheet metal 32 must be closely controlled and selectively modified so as to render the polymeric core compliant enough to yield and form a bond, but not so high as to deform the metallic constraining layer. Ideally, the first strip of sheet metal 32 is between 182-193° C. (360-380° F.), whereas the second strip of sheet metal 62 is between 193-204° C. (380-400° F.) during lamination.

By using an underhand payoff and an overhand rewind for the first strip of sheet metal 32 in pass one P1, as well as an overhand payoff of sheet metal 32 and an underhand payoff of sheet metal 62 in pass two P2, the first constraining layer 12 will have a concave down coil orientation that is disposed in opposing relation to the second constraining layer 14 which will have a concave up coil orientation prior to laminating the two members together—i.e., mirrored images. See FIG. 3A. According to prior art practice, the proper orientation has always been to match the coil sets of the two metal members—i.e., both concave up or concave down. With certain draw quality metals, coil set orientation may not matter due to the relatively low springback force constant. For example, in extra-deep draw quality cold rolled steel (EDDQ CRS) laminates, there are no edge-peel or springback stresses in the machine direction. However, to properly process an aluminum metal laminate, which is more sensitive to coil set than steel is, the opposing coil set orientation may be critical to maintain lamination.

The thermally activated sheet metal 32 and 62 are then compressed together, for example, by passing the sheets 32, 62 through a nip press, defined by mutually coacting and opposing lam rolls 78, in a substantially continuous manner, to form the laminate structure 10. The nip press lamination pressure is preferably about 90-100 pounds per square inch (psi) (6-7 kg/cm²). Where required, post lamination cooling is achieved, for example, through fourth quenching device 80. Finally, the married first and second strips of sheet metal 32 and 62 (which may be considered the constrained layer laminate damping structure 10 of FIG. 1) are rewound into a second rewind coil 82 in an overhand manner.

While the best modes for carrying out the present invention have been described in detail, those familiar with the art to which this invention relates will recognize various alternative designs and embodiments for practicing the invention within the scope of the appended claims.

1. A laminate structure for attenuating vibration and damping noise, comprising:
a first metallic constraining layer;
a second metallic constraining layer; and
a viscoelastic layer disposed between and bonded to said first and second metallic constraining layers, said viscoelastic layer including an amount of an external cross-linking agent in excess of a stoichiometric quantity of said cross-linking agent.

2. The laminate structure of claim 1, wherein said external cross-linking agent consists essentially of a metal acetylacetonate.

3. The laminate structure of claim 1, further comprising:
at least one layer of hexavalent chrome free pretreatment disposed between and bonded to said viscoelastic layer and at least one of said first and second constraining layers.

4. The laminate structure of claim 3, wherein said at least one layer of hexavalent chrome free pretreatment is 100% inorganic.

5. The laminate structure of claim 3, wherein said at least one layer of hexavalent chrome free pretreatment consists essentially of an aqueous chromium (III) phosphate-silicate.

6. The laminate structure of claim 3, wherein said at least one layer of hexavalent chrome free pretreatment has a total coating weight of approximately 161 to 269 milligrams per square meter.

7. The laminate structure of claim 3, further comprising:
at least one layer of fluorotitanate-fluorozirconate pretreatment disposed between said at least one layer of hexavalent chrome free pretreatment and said at least one of said first and second constraining layers.

8. The laminate structure of claim 1, wherein said first and second constraining layers are aluminum.

9. The laminate structure of claim 1, wherein said viscoelastic layer consists essentially of a polymeric acrylic.

10. The laminate structure of claim 9, wherein said viscoelastic layer has a minimum shear strength of 3 megapascals and a moderate room temperature peel resistance of approximately 90-143 kilograms per meter width.

11. A laminate structure for attenuating vibration and damping noise, comprising:
a first metallic constraining layer;
a second metallic constraining layer; and
a viscoelastic layer disposed between and extending substantially the entirety of said first and second metallic constraining layers;
a first layer of hexavalent chrome free pretreatment disposed between and bonded to said first constraining layer and said viscoelastic layer; and
a second layer of hexavalent chrome free pretreatment disposed between and bonded to said second constraining layer and said viscoelastic layer;
wherein said first and second layers of hexavalent chrome free pretreatment is characterized as an aqueous chromium (III) phosphate-silicate.

12. The laminated structure of claim 11, wherein said first and second layers of hexavalent chrome free pretreatment are 100% inorganic.

13. The laminated structure of claim 11, said viscoelastic layer includes an amount of an external cross-linking agent in excess of a stoichiometric quantity of said cross-linking agent.

14. The laminate structure of claim 13, wherein said external cross-linking agent consists essentially of a metal acetylacetonate.

15. The laminate structure of claim 11, further comprising:
a first layer of fluorotitanate-fluorozirconate pretreatment disposed between and bonded to said first layer of hexavalent chrome free pretreatment and said first constraining layer; and
a second layer of fluorotitanate-fluorozirconate pretreatment disposed between and bonded to said second layer of hexavalent chrome free pretreatment and said second constraining layer.

16. A method of manufacturing a laminate damping structure with at least one viscoelastic core disposed between and bonded to first and second metallic constraining layers, the method comprising:
applying the viscoelastic layer to at least one of the first and second constraining layers; and
laminating the first constraining layer to the second constraining layer;
wherein the first constraining layer has a concave down coil orientation and the second constraining layer has a concave up coil orientation disposed in opposing relation to said concave down coil orientation prior to said laminating.

17. The method of claim 16, further comprising:
uncoiling the first constraining layer from a first coil of sheet metal in an underhand manner prior to said applying a first layer of pretreatment;
rewinding the first constraining layer into a second coil of sheet metal in an overhand manner after said applying a first layer of pretreatment;
uncoiling the second constraining layer from a third coil of sheet metal in an underhand manner prior to said applying a second layer of pretreatment; and
uncoiling said third coil of sheet metal in an underhand manner prior to said laminating the first constraining layer to the second constraining layer.

18. The method of claim 16, further comprising:
adding an amount of an external cross-linking agent to the viscoelastic layer prior to said applying the viscoelastic layer, said amount being greater than a stoichiometric quantity of said cross-linking agent.

19. The method of claim 16, further comprising:
applying a first layer of aqueous chromium (III) phosphate-silicate to the first constraining layer over said first layer of pretreatment prior to said laminating the first constraining layer to the second constraining layer; and
applying a second layer of aqueous chromium (III) phosphate-silicate to the second constraining layer over said second layer of pretreatment prior to said laminating the first constraining layer to the second constraining layer.

20. The method of claim 16, further comprising:
applying a first layer of pretreatment to the first constraining layer prior to said laminating the first constraining layer to the second constraining layer; and
applying a second layer of pretreatment to the second constraining layer prior to said laminating the first constraining layer to the second constraining layer;
wherein said first and second layers of pretreatment consist essentially of fluorotitanate-fluorozirconate immersion pretreatment.
